(19) United States
(12) Patent Application Publication
(10) Pub. No.: US 2015/0045196 A1
(43) Pub. Date: Feb. 12, 2015

(54) METHOD OF PRODUCING ELECTRICALLY CONDUCTIVE FOAM RUBBER ROLLER, ELECTRICALLY CONDUCTIVE FOAM RUBBER ROLLER, AND IMAGE FORMING APPARATUS

(71) Applicant: SUMITOMO RUBBER INDUSTRIES, LTD., Kobe-shi (JP)

(72) Inventors: Takuya YAMAGUCHI, Kobe-shi (JP); Shunichi YABUSHITA, Kobe-shi (JP); Masafumi YAMAMOTO, Kobe-shi (JP)

(21) Appl. No.: 14/337,730

(22) Filed: Jul. 22, 2014

(30) Foreign Application Priority Data
Aug. 7, 2013 (JP) 2013-164370

(51) Int. Cl. B29C 47/00; F16C 1/00; B29D 23/00

(52) U.S. Cl. CPC B29C 47/0023; B29D 23/00; F16C 1/00; B29K 2019/00
USPC 492/57; 264/406

(57) ABSTRACT

The present invention provides a production method for producing an electrically conductive foam rubber roller which has a tubular body free from internal abnormal foaming and hence free from internal cracking after the foaming. The production method includes the steps of: continuously extruding a rubber composition into a tubular body (7); and passing the extruded tubular body (7) through a microwave crosslinking device (8) and then through a hot air crosslinking device (9) in an elongated state without cutting the tubular body. The rubber composition is extruded, foamed and crosslinked so that the tubular body has a thickness unevenness of not greater than 1.3 immediately after being passed through the hot air crosslinking device (9), the thickness unevenness being defined as a ratio Tₘₐₓ/Tₘᵢₙ between a maximum radial thickness Tₘₐₓ and a minimum radial thickness Tₘᵢₙ of the tubular body which are each measured in a cross section of the tubular body.

### TECHNICAL FIELD

The present invention relates to a production method for producing an electrically conductive foam rubber roller, an electrically conductive foam rubber roller produced by the production method, and an image forming apparatus incorporating the electrically conductive foam rubber roller.

### BACKGROUND ART

In electrophotographic image forming apparatuses such as a laser printer, an electrostatic copying machine, a plain paper facsimile machine and a copier-printer-facsimile multifunction machine, an image is generally formed on a surface of a sheet (the term. “sheet” is herein defined to include a paper sheet, a plastic film such as an OHP film and the like, and this definition is effective in the following description) through the following process steps.

First, a surface of a photoreceptor body having photoelectric conductivity is evenly electrically charged and, in this state, exposed to light, whereby an electrostatic latent image corresponding to an image to be formed on the sheet is formed on the surface of the photoreceptor body (charging step and exposing step).

Then, a toner (minute color particles) preliminarily electrically charged at a predetermined potential is brought into contact with the surface of the photoreceptor body. Thus, the toner selectively adheres to the surface of the photoreceptor body according to the potential pattern of the electrostatic latent image, whereby the electrostatic latent image is developed into a toner image (developing step).

Subsequently, the toner image is transferred onto the surface of the sheet (transfer step), and fixed to the surface of the sheet (fixing step). Thus, the image is formed on the surface of the sheet.

In the transfer step, the toner image formed on the surface of the photoreceptor body may be directly transferred to the surface of the sheet, or may be once transferred to a surface of an image carrier (first transfer step) and then transferred to the surface of the sheet (second transfer step).

Further, toner remaining on the surface of the photoreceptor body after the transfer step is removed (cleaning step). Thus, a process sequence for the image formation ends.

In the photoreceptor body charging step, the developing step, the transfer step and the cleaning step out of the aforementioned process steps, rubber rollers are used. Widely used as the rubber rollers are electrically conductive foam rubber rollers which each include a tubular foam rubber body imparted with electrical conductivity suitable for a specific use purpose thereof and are brought into contact with the surface of the photoreceptor body.

The following continuous method is known for production of the electrically conductive foam rubber rollers (Patent Literatures 1 to 4).

That is, an electrically-conductive crosslinkable foamable rubber composition is continuously extruded into a tubular body by means of an extruder, and the extruded tubular body is continuously passed through a microwave crosslinking device and a hot air crosslinking device in an elongated state without cutting thereof to be thereby continuously foamed and crosslinked.

Then, the tubular body is cut to a predetermined length and secondarily crosslinked, and a shaft is inserted into and fixed to a through-hole of the tubular body. Then, an outer peripheral surface of the tubular body is polished to be finished as having a predetermined outer diameter.

### CITATION LIST

### Patent Literature

Patent Literature 1: JP2007-322729A
Patent Literature 2: JP2008-90236A
Patent Literature 3: JP2010-145920A
Patent Literature 4: JP2010-217521A

### SUMMARY OF THE INVENTION

### Problems to be Solved by the Invention

One problem associated with the continuous production of the electrically conductive foam rubber roller is such that the tubular body is liable to be locally abnormally foamed and hence suffer from internal cracking after the foaming.

If the internal cracking is present in the tubular body, the cracking is likely to extend to an outer peripheral surface of the electrically conductive foam rubber roller when the rubber roller is thereafter polished, and the cracked outer peripheral surface is liable to be exfoliated. Even if the cracking does not extend to the outer peripheral surface, the outer peripheral surface may be indented due to the internal cracking.

The exfoliation and the indentation disadvantageously influence the outer diameter dimensional accuracy and the hardness of the electrically conductive rubber roller.

It is an object of the present invention to provide a production method for producing an electrically conductive foam rubber roller without the internal cracking due to the internal abnormal foaming of a tubular body of the rubber roller after the foaming step and hence without the exfoliation and the indentation of the tubular body in the subsequent polishing step. It is another object of the present invention to provide an electrically conductive foam rubber roller produced by the production method, and to provide an image forming apparatus incorporating the electrically conductive foam rubber roller.

### Means for Solving the Problems

The present invention provides a production method for producing an electrically conductive foam rubber roller, the production method comprising the steps of: continuously extruding an electrically-conductive crosslinkable foamable rubber composition into a tubular body; and passing the extruded tubular body through a microwave crosslinking device and then through a hot air crosslinking device in an elongated state without cutting the tubular body to continuously foam and crosslink the tubular body, wherein the rubber composition is extruded, foamed and crosslinked so that the tubular body has a thickness unevenness of not greater than 1.3 immediately after the foaming, the thickness unevenness being defined as a ratio Tₘₐₓ/Tₘᵢₙ between a maximum radial thickness Tₘₐₓ and a minimum radial thickness Tₘᵢₙ of the tubular body which are each measured radially of the tubular body in a cross section of the tubular body.

According to studies conducted by the inventor of the present invention, a tubular body locally abnormally foamed in the foaming step to thereafter suffer from cracking is liable to have uneven thickness as radially measured, i.e., suffer from thickness unevenness.

Where the tubular body is formed by extruding, foaming and crosslinking the rubber composition so that the tubular body has a thickness unevenness of not greater than 1.3 immediately after being passed through the hot air crosslinking device (the thickness unevenness is herein defined as the ratio Tₘₐₓ/Tₘᵢₙ between the maximum radial thickness Tₘₐₓ and the minimum radial thickness Tₘᵢₙ of the tubular body which are each measured radially of the tubular body in the cross section of the tubular body), in contrast, the tubular body is prevented from suffering from the internal local abnormal foaming in the foaming step and hence prevented from suffering from the internal cracking after the foaming step.

Therefore, the electrically conductive foam rubber roller can be produced without the exfoliation and the indentation of the tubular body thereof in the subsequent polishing step and hence without any influence on the outer diameter dimensional accuracy and the hardness of the tubular body.

In order to control the thickness unevenness within the aforementioned range, the tubular body should be formed by the extrusion so as to have as uniform thickness as possible, and foamed and crosslinked as uniformly as possible.

In order to reduce the thickness unevenness, it is particularly important to extrude the rubber composition so that the thickness of the tubular body is as uniform as possible.

For this purpose, an extruder including a die head having a round opening and a center core provided in the die head and having a round cross section taken along the same plane as the opening of the die head is used, wherein the die head and the center core are positioned with respect to each other so that an error calculated from the following expression (1) is not greater than 10%:

Error(%)=(Max−Min)/Min×100 (1)

wherein Max and Min are a maximum value and a minimum value, respectively, of distances as measured between the opening of the die head and the center core radially of the opening in the same plane as the opening at different positions defined circumferentially of the opening.

With this arrangement, the rubber composition is extruded through an annular space defined between the die head and the center core to form the tubular body, and the thickness unevenness of the tubular body before the foaming step is minimized. Then, the tubular body is passed through the microwave crosslinking device and then through the hot air crosslinking device to be thereby continuously foamed and crosslinked so that the thickness unevenness of the tubular body is not greater than 1.3 immediately after being passed through the hot air crosslinking device. Thus, the tubular body is further reliably prevented from suffering from the internal local abnormal foaming in the foaming step and hence prevented from suffering from the internal cracking after the foaming step.

The present invention also provides an electrically conductive foam rubber roller produced by the inventive production method.

According to the present invention, the electrically conductive foam rubber roller produced by the inventive production method described above is free from the exfoliation and the indentation of the tubular body thereof which may otherwise influence the dimensional accuracy and the hardness of the tubular body.

The present invention further provides an image forming apparatus which incorporates the inventive electrically conductive foam rubber roller.

According to the present invention, the inventive electrically conductive foam rubber roller free from the exfoliation and the indentation of the tubular body thereof which may otherwise influence the dimensional accuracy and the hardness of the tubular body is incorporated, for example, as a transfer roller in the image forming apparatus. Thus, the image forming apparatus is excellent in imaging characteristic properties.

### Effects of the Invention

According to the present invention, the production method is provided, which can produce the electrically conductive foam rubber roller without the internal cracking due to the internal abnormal foaming of the tubular body of the rubber roller after the foaming step and hence without the exfoliation and the indentation of the tubular body in the subsequent polishing step. According to the present invention, the electrically conductive foam rubber roller produced by the aforementioned production method, and the image forming apparatus incorporating the electrically conductive foam rubber roller are also provided.

### BRIEF DESCRIPTION OF THE DRAWINGS

FIG. 1 is a block diagram for explaining the steps of extruding, foaming and crosslinking a rubber composition in an electrically conductive foam rubber roller production method according to one embodiment of the present invention.

FIG. 2 is a perspective view of an inventive electrically conductive foam rubber roller produced by the inventive production method including the process steps shown in FIG. 1.

FIG. 3 is a sectional view for explaining how to determine the radial thickness unevenness of a tubular body produced through the process steps shown in FIG. 1 immediately after the tubular body is passed through a hot air crosslinking device.

FIG. 4 is a perspective view for explaining a die head and a center core for use in the extrusion of the rubber composition in the process of FIG. 1 by way of example.

FIG. 5 is a front view for explaining how to determine an error of a radial distance between the die head and the center core in the example shown in FIG. 4.

### EMBODIMENTS OF THE INVENTION

<<Electrically Conductive Foam Rubber Roller Production Method, and Electrically Conductive Foam Rubber Roller>>

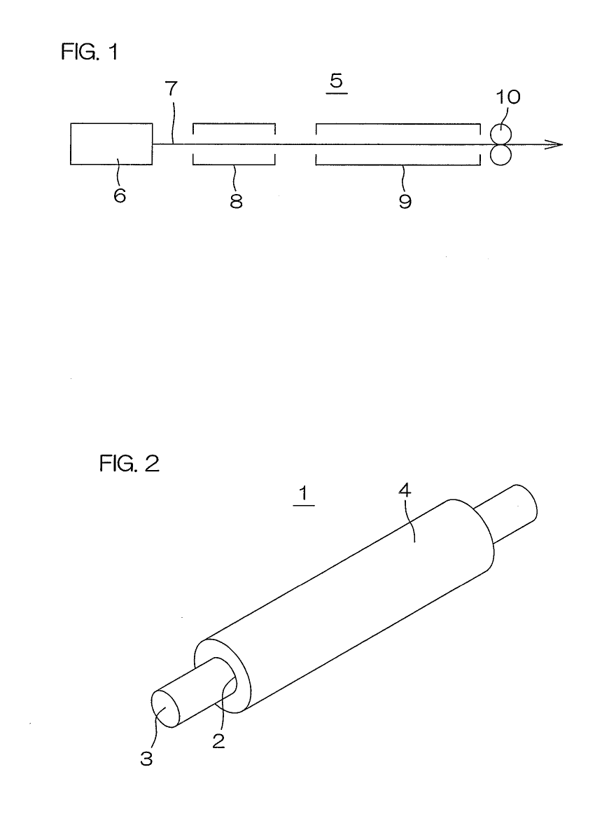

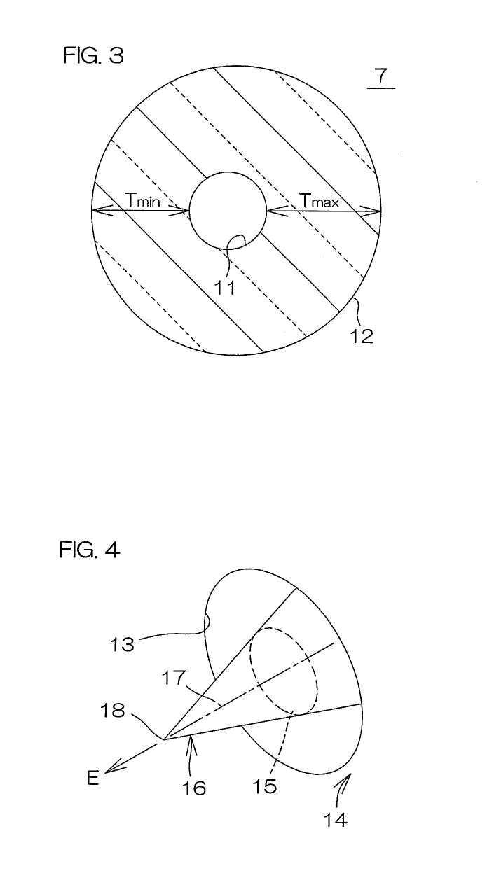

FIG. 1 is a block diagram for explaining the steps of extruding, foaming and crosslinking a rubber composition in an electrically conductive foam rubber roller production method according to one embodiment of the present invention. FIG. 2 is a perspective view of an inventive electrically conductive foam rubber roller produced by the inventive production method including the process steps shown in FIG. 1. FIG. 3 is a sectional view for explaining how to determine the radial thickness unevenness of a tubular body produced through the process steps shown in FIG. 1 immediately after the tubular body is passed through a hot air crosslinking device.

Referring to FIG. 2, the electrically conductive foam rubber roller 1 according to this embodiment is produced by forming a tubular body of a single layer structure from an electrically-conductive crosslinkable foamable rubber composition, inserting a shaft 3 into a center through-hole 2 of the tubular body to fix the shaft 3 to the tubular body, and polishing an outer peripheral surface 4 of the tubular body.

Referring to FIG. 1, a production apparatus 5 to be used for the production method according to this embodiment includes an extruder 6 for continuously extruding the rubber composition into a tubular shape, a microwave crosslinking device 8 and a hot air crosslinking device 9 provided in this order on a continuous transportation path along which a tubular body 7 formed by the extrusion is continuously transported in an elongated state without cutting by a conveyor (not shown) or the like, and a take-up device 10 adapted to take up the tubular body 7 at a predetermined speed.

In the inventive production method, the electrically-conductive crosslinkable foamable rubber composition prepared for the tubular body 7 by blending a rubber component, a foaming agent and the like in predetermined proportions is formed into a ribbon shape, and continuously fed into the extruder 6 to be continuously extruded into the elongated tubular body 7 by operating the extruder 6.

In turn, the extruded tubular body 7 is continuously transported at the predetermined speed by the conveyor and the take-up device 10 to be first passed through the microwave crosslinking device 8, whereby the rubber composition forming the tubular body 7 is crosslinked to a certain crosslinking degree by irradiation with microwave. Further, the inside of the microwave crosslinking device 8 is heated to a predetermined temperature, whereby the rubber composition is further crosslinked, and foamed by decomposition of the foaming agent.

Subsequently, the tubular body 7 is further transported to be passed through the hot air crosslinking device 9, whereby hot air is applied to the tubular body 7. Thus, the rubber composition is further foamed by the decomposition of the foaming agent, and crosslinked to a predetermined crosslinking degree.

In the inventive production method, the rubber composition is extruded, foamed and crosslinked so that the tubular body 7 has a thickness unevenness of not greater than 1.3 immediately after being passed through the hot air crosslinking device 9 in the process shown in FIG. 1. Referring to FIG. 3, the thickness unevenness is defined as a ratio Tₘₐₓ/Tₘᵢₙ between a maximum radial thickness (maximum thickness) Tₘₐₓ and a minimum radial thickness (minimum thickness) Tₘᵢₙ which are each measured radially of the tubular body 7 between the through-hole 11 and the outer peripheral surface 12 of the tubular body 7 in a cross section of the tubular body 7.

Thus, the tubular body 7 is prevented from suffering from the internal local abnormal foaming in the foaming step and hence prevented from suffering from the internal cracking after the foaming step.

The lower limit of the thickness unevenness is 1. That is, it is ideal that the tubular body 7 is free from the thickness unevenness.

In consideration of the productivity of the electrically conductive foam rubber roller 1 and the like, however, it is preferred to extrude, foam and crosslink the rubber composition while controlling the thickness unevenness in a range of not less than 1 and not greater than 1.3. This is because, with a thickness unevenness of not greater than 1.3, substantially the same effects can be provided.

The thickness unevenness is preferably not greater than 1.26 in order to impart the electrically conductive foam rubber roller 1 with a predetermined outer diameter and suppress the deflection of the outer peripheral surface 4 while minimizing the polishing amount of the outer peripheral surface 4 in the polishing step to reduce the use amount of the rubber composition.

In order to control the thickness unevenness within the aforementioned range, the tubular body 7 should be formed so as to have as uniform thickness as possible by the extrusion, and foamed and crosslinked as uniformly as possible.

In order to reduce the thickness unevenness, it is particularly important to extrude the rubber composition so that the thickness of the tubular body 7 is as uniform as possible.

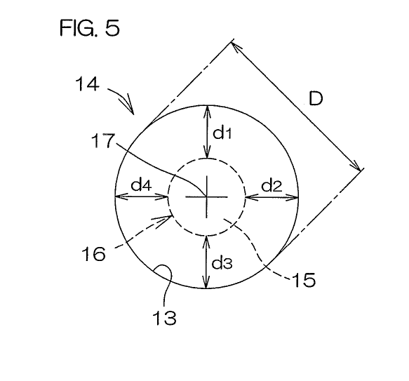

FIG. 4 is a perspective view for explaining a die head and a center core for use in the extrusion of the rubber composition in the process of FIG. 1 by way of example. FIG. 5 is a front view for explaining how to determine an error of a radial distance between the die head and the center core in the example shown in FIG. 4.

Referring to FIG. 4, a die head 14 having a round opening 13 and a center core 16 provided in the die head 14 and having a round cross section 15 taken along the same plane as the opening of the die head 14 are used in combination for extruding the rubber composition into the tubular shape.

The center core 16 has a conical shape, and is positioned in the die head 14 with its axis 17 (indicated by a one-dot-and-dash line in FIG. 4) aligned with a tubular body extruding direction E (indicated by a solid line arrow in FIG. 4) and with its apex 18 directed in the extruding direction E and projecting out of the opening 13 of the die head 14 in the extruding direction E.

In order to form the tubular body 7 having as uniform thickness as possible by the extrusion with the use of the die head 14 and the center core 16 in combination, it is preferred to position the die head 14 and the center core 16 with respect to each other so that an error calculated from the expression (1) based on a maximum value and a minimum value of radial distances as measured between the opening 13 of the die head 14 and the center core 16 in a section 15 of the center core 16 taken along the same plane as the opening 13 at different positions defined circumferentially of the opening 13 is not greater than 10%. In this state, the rubber composition is extruded into the tubular shape through an annular space defined between the die head 14 and the center core 16.

For the control of the error, it is preferred to utilize an urge amount controlling function of a fixing mechanism which is adapted to urge and fix the die head 14 with respect to the axis 17 of the center core 16 in four directions, i.e., in upward, rightward, downward and leftward directions, by means of screws or the like. Referring to FIG. 5, urge amounts to be applied in the four directions by the fixing mechanism not shown are controlled so that an error calculated from the expression (1) based on a maximum value and a minimum value of distances d1 to d4 which are measured between the opening 13 of the die head 14 and the center core 16 in four directions (corresponding to the four directions of the fixing mechanism), i.e., in upward, rightward, downward and leftward directions, with respect to the axis 17 is not greater than 10%.

Thus, the thickness unevenness of the tubular body 7 formed by extruding the rubber composition through the annular space defined between the die head 14 and the center core 16 before the foaming can be minimized, whereby the thickness unevenness of the tubular body 7 continuously foamed and crosslinked by the passage through the microwave crosslinking device 8 and then through the hot air crosslinking device 9 is adjusted to not greater than 1.3 immediately after the passage through the hot air crosslinking device 9. Thus, the tubular body 7 is more reliably prevented from suffering from the internal local abnormal foaming in the foaming step and hence prevented from suffering from the internal cracking after the foaming step.

The lower limit of the error to be calculated from the expression (1) is ideally 0%. With an error of not greater than 10%, however, substantially the same effects can be provided. For simplification of the adjustment operation and higher productivity of the electrically conductive foam rubber roller 1, the extrusion is preferably performed so that the error is controlled within a range of not less than 0% and not greater than 10%.

In order to control the thickness unevenness to not greater than 1.3, as described above, it is effective to foam and crosslink the extruded tubular body 7 as uniformly as possible.

Since the microwave crosslinking device 8 and the hot air crosslinking device 9 to be used for the continuous method are generally designed in consideration of the uniform foaming and crosslinking, additional consideration is not required when the extruded tubular body 7 is passed through these devices.

However, the tubular body 7 being transported may be twisted so that the microwave irradiation dose and the heating degree can be made more uniform throughout the entire tubular body 7 for more uniform foaming and crosslinking.

Thereafter, the foamed and crosslinked tubular body 7 is cut to a predetermined length and, as required, heated in a hot air oven or the like to be secondarily crosslinked. Then, as shown in FIG. 2, the shaft 3 is inserted into and fixed to the through-hole 2, and the outer peripheral surface 4 is polished. Thus, the electrically conductive foam rubber roller 1 is produced, which is electrically connected to and mechanically fixed to the shaft 3 as shown in FIG. 2.

The polishing step may be performed at any time in the production process. For improvement of workability and suppression of the deflection of the outer peripheral surface 4, however, it is preferred to cut the tubular body 7 to a predetermined length and insert and fix the shaft 3 in the tubular body 7 as shown in FIG. 2 and, in this state, polish the outer peripheral surface 4 while rotating the tubular body 7 about the shaft 3.

According to the present invention, the tubular body 7 has a thickness unevenness of not greater than 1.3 at this time as described above. The tubular body 7 is free from the internal cracking which may otherwise occur due to the internal abnormal foaming and, therefore, free from the exfoliation and the indentation in the polishing step. Thus, the electrically conductive foam rubber roller 1 can be produced without any influence on the outer diameter dimensional accuracy and the hardness of the tubular body 7.

According to the present invention, the continuous method improves the productivity, thereby advantageously reducing the production costs of the electrically conductive foam rubber roller 1.

The shaft 3 is a unitary member made of a metal such as aluminum, an aluminum alloy or a stainless steel.

A shaft having an outer diameter greater than the inner diameter of the through-hole 2 may be used as the shaft 3, and press-inserted into the through-hole 2 to be electrically connected to and mechanically fixed to the electrically conductive foam rubber roller 1. Alternatively, the shaft 3 may be electrically connected to and mechanically fixed to the electrically conductive foam rubber roller 1, for example, via an electrically conductive thermosetting adhesive agent.

In the latter case, the electrically conductive foam rubber roller 1 may be secondarily crosslinked when the thermosetting adhesive agent is cured by the heating in the hot air oven.

The microwave crosslinking device 8 and the hot air crosslinking device 9 are detailed, for example, in Patent Literatures 1 to 3 described above.

The electrically conductive foam rubber roller 1 may be incorporated, for example, as a charging roller, a developing roller, a transfer roller or the like in an electrophotographic image forming apparatus.

The electrically conductive foam rubber roller 1 preferably has an ASKER-C hardness of not higher than 50 degrees as measured with a load of 4.9 N in an ordinary temperature and ordinary humidity environment at a temperature of 23° C. at a relative humidity of 55% by a measurement method specified by the Society of Rubber Industry Standards SRIS 0101 “Physical Test Methods for Expanded Rubber.”

An electrically conductive foam rubber roller 1 having an ASKER-C hardness higher than the aforementioned range is insufficient in flexibility. If such an electrically conductive foam rubber roller is used as a transfer roller, for example, it will be impossible to provide the effect of improving the toner transfer efficiency by providing a sufficiently great nip width and the effect of suppressing the damage to the photoreceptor body.

In order to control the ASKER-C hardness, for example, the types and the amounts of the ingredients of the rubber composition may be properly determined.

### <<Rubber Composition>>

Usable as the rubber composition for the electrically conductive foam rubber roller 1 is a rubber composition which is extrudable into a tubular shape by means of the extruder 6, foamable and crosslinkable when being passed through the microwave crosslinking device 8 and the hot air crosslinking device 9, and has an electrical conductivity suitable for the use purpose of the electrically conductive foam rubber roller 1.

Particularly, a rubber composition imparted with ion conductivity by blending an ion-conductive rubber as an electrical conductivity imparting agent which also serves for the rubber component.

### <Rubber Component>

An ion-conductive rubber and a crosslinkable rubber are preferably used in combination for the rubber component.

### (Ion-Conductive Rubber)

An epichlorohydrin rubber is preferably used as the ion-conductive rubber.

Examples of the epichlorohydrin rubber include epichlorohydrin homopolymers, epichlorohydrin-ethylene oxide bipolymers (ECO), epichlorohydrin-propylene oxide bipolymers, epichlorohydrin-allyl glycidyl ether bipolymers, epichlorohydrin-ethylene oxide-allyl glycidyl ether terpolymers (GECO), epichlorohydrin-propylene oxide-allyl glycidyl ether terpolymers and epichlorohydrin-ethylene oxide-propylene oxide-allyl glycidyl ether quaterpolymers, which may be used either alone or in combination.

Of the aforementioned examples, the ethylene oxide-containing copolymers, particularly the ECO and/or the GECO are preferred as the epichlorohydrin rubber.

These copolymers preferably each have an ethylene oxide content of not less than 30 mol % and not greater than 80 mol %, particularly preferably not less than 50 mol %.

Ethylene oxide functions to reduce the roller resistance of the electrically conductive foam rubber roller 1. If the ethylene oxide content is less than the aforementioned range, however, it will be impossible to sufficiently provide the roller resistance reducing function and hence to sufficiently reduce the roller resistance.

If the ethylene oxide content is greater than the aforementioned range, on the other hand, ethylene oxide is liable to be crystallized, whereby the segment motion of molecular chains is hindered to adversely increase the roller resistance. Further, the electrically conductive foam rubber roller 1 is liable to have a higher hardness after the foaming and the crosslinking, and the rubber composition is liable to have a higher viscosity when being heat-melted before the crosslinking.

The ECO has an epichlorohydrin content that is a balance obtained by subtracting the ethylene oxide content from the total. That is, the epichlorohydrin content is preferably not less than 20 mol % and not greater than 70 mol %, particularly preferably not greater than 50 mol %.

The GECO preferably has an allyl glycidyl ether content of not less than 0.5 mol % and not greater than 10 mol %, particularly preferably not less than 2 mol % and not greater than 5 mol %.

Allyl glycidyl ether per se functions as side chains of the copolymer to provide a free volume, whereby the crystallization of ethylene oxide is suppressed to reduce the roller resistance of the electrically conductive foam rubber roller 1. However, if the allyl glycidyl ether content is less than the aforementioned range, it will be impossible to provide the roller resistance reducing function and hence to sufficiently reduce the roller resistance.

Allyl glycidyl ether also functions as crosslinking sites during the crosslinking of the GECO. Therefore, if the allyl glycidyl ether content is greater than the aforementioned range, the crosslinking density of the GECO is increased, whereby the segment motion of molecular chains is hindered. This may adversely increase the roller resistance. Further, the electrically conductive foam rubber roller 1 is liable to suffer from reduction in breaking elongation, 100% modulus, fatigue resistance and flexural resistance.

The GECO has an epichlorohydrin content that is a balance obtained by subtracting the ethylene oxide content and the allyl glycidyl ether content from the total. That is, the epichlorohydrin content is preferably not less than 10 mol % and not greater than 69.5 mol %, particularly preferably not less than 19.5 mol % and not greater than 60 mol %.

Examples of the GECO include copolymers of the three comonomers described above in a narrow sense, as well as known modification products obtained by modifying an epichlorohydrin-ethylene oxide copolymer (ECO) with allyl glycidyl ether. In the present invention, any of these modification products may be used as the GECO.

The proportion of the epichlorohydrin rubber to be blended is preferably not less than 5 parts by mass and not greater than 40 parts by mass, particularly preferably not less than 10 parts by mass and not greater than 30 parts by mass, based on 100 parts by mass of the overall rubber component.

If the proportion of the epichlorohydrin rubber is less than the aforementioned range, it will be impossible to impart the electrically conductive foam rubber roller 1 with proper ion conductivity.

If the proportion of the epichlorohydrin rubber is greater than the aforementioned range, on the other hand, the proportion of the crosslinkable rubber is relatively reduced. Therefore, it will be impossible to sufficiently provide the effects of the blending of the crosslinkable rubber to be described below.

### (Crosslinkable Rubber)

Examples of the crosslinkable rubber include a styrene butadiene rubber (SBR) and an acrylonitrile butadiene rubber (NBR). These rubbers are excellent in crosslinkability, and are capable of imparting the electrically conductive foam rubber roller 1 with proper elasticity and flexibility after the foaming and the crosslinking.

Where an ethylene propylene diene rubber (EPDM) is further blended as the crosslinkable rubber, the electrically conductive foam rubber roller 1 is improved in resistance to ozone to be generated in an image forming apparatus.

### (SBR, NBR)

Usable as the SBR are various SBRs synthesized by copolymerizing styrene and 1,3-butadiene by various polymerization methods such as an emulsion polymerization method and a solution polymerization method. The SBRs include those of an oil-extension type having flexibility controlled by addition of an extension oil, and those of a non-oil-extension type containing no extension oil. Either type of SBRs is usable.

According to the styrene content, the SBRs are classified into a higher styrene content type, an intermediate styrene content type and a lower styrene content type, and any of these types of SBRs is usable. Physical properties of the electrically conductive foam rubber roller 1 can be controlled by changing the styrene content and the crosslinking degree.

These SBRs may be used either alone or in combination.

Usable examples of the NBR include lower-acrylonitrile-content NBRs, intermediate-acrylonitrile-content NBRs, intermediate- and higher-acrylonitrile-content NBRs, higher-acrylonitrile-content NBRs, and very-high-acrylonitrile-content NBRs, which are classified according to the acrylonitrile content. These NBRs may be used either alone or in combination.

The SBR and the NBR may be used in combination.

The proportion of the SBR and/or the NBR to be blended is preferably not less than 40 parts by mass and not greater than 90 parts by mass, particularly preferably not less than 60 parts by mass and not greater than 80 parts by mass, based on 100 parts by mass of the overall rubber component.

If the proportion of the SBR and/or the NBR is less than the aforementioned range, it will be impossible to sufficiently provide the effect of imparting the rubber composition with proper crosslinkability and the effect of imparting the electrically conductive foam rubber roller 1 with proper elasticity and flexibility after the foaming and the crosslinking as described above by using the SBR and/or the NBR.

If the proportion of the SBR and/or the NBR is greater than the aforementioned range, on the other hand, the proportion of the EPDM is relatively reduced, making it impossible to impart the electrically conductive foam rubber roller 1 with excellent ozone resistance. Further, the proportion of the epichlorohydrin rubber is also relatively reduced, making it impossible to impart the electrically conductive foam rubber roller 1 with proper ion conductivity.

Where an oil-extension type SBR is used, the proportion of the SBR described above is defined as the solid proportion of the SBR contained in the oil-extension type SBR. Where the SBR and the NBR are used in combination, the total proportion of the SBR and the NBR is within the aforementioned range.

### (EPDM)

Usable as the EPDM are various EPDMs each prepared by introducing double bonds to a main chain thereof by employing a small amount of a third ingredient (diene) in addition to ethylene and propylene.

Various products containing different types of third ingredients in different amounts are commercially available. Typical examples of the third ingredients include ethylidene norbornene (ENB), 1,4-hexadiene (1,4-HD) and dicyclopentadiene (DCP). A Ziegler catalyst is typically used as a polymerization catalyst.

The proportion of the EPDM to be blended is preferably not less than 5 parts by mass and not greater than 40 parts by mass, particularly preferably not greater than 20 parts by mass, based on 100 parts by mass of the overall rubber component.

If the proportion of the EPDM is less than the aforementioned range, it will be impossible to impart the electrically conductive foam rubber roller 1 with excellent ozone resistance.

If the proportion of the EPDM is greater than the aforementioned range, on the other hand, the proportion of the SBR and/or the NBR is relatively reduced, making it impossible to sufficiently provide the effect of imparting the rubber composition with proper crosslinkability and the effect of imparting the electrically conductive foam rubber roller 1 with proper elasticity and flexibility after the foaming and the crosslinking by blending the SBR and/or the NBR. Further, the proportion of the epichlorohydrin rubber is also relatively reduced, making it impossible to impart the electrically conductive foam rubber roller 1 with proper ion conductivity.

(Other Rubber)

A polar rubber such as a chloroprene rubber (CR), a butadiene rubber (BR) or an acryl rubber (ACM) may be blended as the rubber component to finely control the roller resistance of the electrically conductive foam rubber roller 1.

### <Foaming Component>

A foaming component for foaming the rubber composition is blended in the rubber composition.

As the foaming component, a foaming agent which is thermally decomposed to generate gas to foam the rubber composition is preferably used alone in a proportion of not less than 1 part by mass and not greater than 10 parts by mass based on 100 parts by mass of the overall rubber component. Alternatively, not less than 1 part by mass and not greater than 10 parts by mass of the foaming agent and not greater than 5 parts by mass of a foaming assisting agent based on 100 parts by mass of the overall rubber component are preferably used in combination as the foaming component.

Where the foaming agent which is thermally decomposed to generate gas is used alone as the foaming component without the use of a foaming assisting agent which reduces the decomposition temperature of the foaming agent to reduce the foam cell diameters, or where the foaming assisting agent is blended as the foaming component in a proportion limited to the aforementioned range, the foam cell diameters can be increased in the entire electrically conductive foam rubber roller 1.

Where the proportion of the foaming agent is within the aforementioned range, it is possible to properly foam the tubular body 7 while suppressing the abnormal foaming described above. In addition, the outer peripheral surface 4 and the inner peripheral surface of the tubular body 7 each have a perfectly round sectional shape after the foaming and the crosslinking. Further, the tubular body 7 has a more uniform inner diameter and a more uniform foam cell distribution. Thus, the electrically conductive foam rubber roller 1 can be produced, which is substantially free from variations in hardness and electrical conductivity.

For further improvement of these effects, the proportion of the foaming agent is preferably not less than 1.5 parts by mass and not greater than 8 parts by mass based on 100 parts by mass of the overall rubber component. Most preferably, the foaming assisting agent is not blended.

Examples of the foaming agent include azodicarbonamide (H₂NOCN=NCONH₂, ADCA), 4,4′-oxybis(benzenesulfonylhydrazide) (OBSH) and N,N-dinitrosopentamethylene tetramine (DPT), which may be used either alone or in combination.

An example of the foaming assisting agent is urea.

### <Crosslinking Component>

A crosslinking component for crosslinking the rubber component is blended in the rubber composition. The crosslinking component includes a crosslinking agent and an accelerating agent.

Examples of the crosslinking agent include a sulfur crosslinking agent, a thiourea crosslinking agent, a triazine derivative crosslinking agent, a peroxide crosslinking agent and monomers, which may be used either alone or in combination. Among these crosslinking agents, the sulfur crosslinking agent is preferred.

Examples of the sulfur crosslinking agent include sulfur powder and organic sulfur-containing compounds. Examples of the organic sulfur-containing compounds include tetramethylthiuram disulfide and N,N-dithiobismorpholine. Sulfur such as the sulfur powder is particularly preferred.

The proportion of sulfur to be blended is preferably not less than 0.2 parts by mass and not greater than 5 parts by mass, particularly preferably not less than 1 part by mass and not greater than 3 parts by mass, based on 100 parts by mass of the overall rubber component.

If the proportion of sulfur is less than the aforementioned range, the rubber composition is liable to have a lower crosslinking speed as a whole, requiring a longer period of time for the crosslinking to reduce the productivity of the electrically conductive foam rubber roller 1. If the proportion of sulfur is greater than the aforementioned range, the electrically conductive foam rubber roller 1 is liable to have a higher compression set after the foaming and the crosslinking, or an excess amount of sulfur is liable to bloom on the outer peripheral surface 4 of the electrically conductive foam rubber roller 1.

Examples of the accelerating agent include inorganic accelerating agents such as lime, magnesia (MgO) and litharge (PbO), and organic accelerating agents, which may be used either alone or in combination.

Examples of the organic accelerating agents include: guanidine accelerating agents such as di-o-tolylguanidine, 1,3-diphenylguanidine, 1-o-tolylbiguanide and a di-o-tolylguanidine salt of dicatechol borate; thiazole accelerating agents such as 2-mercaptobenzothiazole and di-2-benzothiazyl disulfide; sulfenamide accelerating agents such as N-cyclohexyl-2-benzothiazylsulfenamide; thiuram accelerating agents such as tetramethylthiuram monosulfide, tetramethylthiuram disulfide, tetraethylthiuram disulfide and dipentamethylenethiuram tetrasulfide; and thiourea accelerating agents, which may be used either alone or in combination.

According to the type of the crosslinking agent to be used, at least one optimum accelerating agent is selected from the various accelerating agents described above for use in combination with the crosslinking agent. For use in combination with the sulfur crosslinking agent, for example, the accelerating agent is preferably selected from the thiuram accelerating agents and the thiazole accelerating agents.

Different types of accelerating agents have different crosslinking accelerating mechanisms and, therefore, are preferably used in combination. The proportions of the accelerating agents to be used in combination may be properly determined, and are preferably not less than 0.1 part by mass and not greater than 10 parts by mass, particularly preferably not less than 0.5 parts by mass and not greater than 6 parts by mass, based on 100 parts by mass of the overall rubber component.

The crosslinking component may further include an acceleration assisting agent.

Examples of the acceleration assisting agent include: metal compounds such as zinc white; fatty acids such as stearic acid, oleic acid and cotton seed fatty acids; and other conventionally known acceleration assisting agents, which may be used either alone or in combination.

The proportion of the acceleration assisting agent to be blended is properly determined according to the types and combination of the rubbers of the rubber component, and the types and combination of the crosslinking agent and the accelerating agent.

<Other Ingredients>

As required, various additives may be added to the rubber composition. Examples of the additives include an acid accepting agent, a plasticizing component (a plasticizer, a processing aid and the like), a degradation preventing agent, a filler, an anti-scorching agent, a UV absorbing agent, a lubricant, a pigment, an anti-static agent, a flame retarder, a neutralizing agent, a nucleating agent, a co-crosslinking agent and the like.

In the presence of the acid accepting agent, chlorine-containing gases generated from the epichlorohydrin rubber during the crosslinking of the rubber component are prevented from remaining in the electrically conductive foam rubber roller 1. Thus, the acid accepting agent functions to prevent the inhibition of the crosslinking and the contamination of a photoreceptor body, which may otherwise be caused by the chlorine-containing gases.

Any of various substances serving as acid acceptors may be used as the acid accepting agent. Preferred examples of the acid accepting agent include hydrotalcites and Magsarat which are excellent in dispersibility. Particularly, the hydrotalcites are preferred.

Where the hydrotalcites are used in combination with magnesium oxide or potassium oxide, a higher acid accepting effect can be provided, thereby more reliably preventing the contamination of the photoreceptor body.

The proportion of the acid accepting agent to be blended is preferably not less than 0.2 parts by mass and not greater than 5 parts by mass, particularly preferably not less than 0.5 parts by mass and not greater than 3 parts by mass, based on 100 parts by mass of the overall rubber component.

If the proportion of the acid accepting agent is less than the aforementioned range, it will be impossible to sufficiently provide the effect of the blending of the acid accepting agent. If the proportion of the acid accepting agent is greater than the aforementioned range, the electrically conductive foam rubber roller 1 is liable to have an increased hardness after the foaming and the crosslinking.

Examples of the plasticizer include plasticizers such as dibutyl phthalate (DBP), dioctyl phthalate (DOP) and tricresyl phosphate, and waxes such as polar waxes. Examples of the processing aid include fatty acids such as stearic acid.

The proportion of the plasticizing component to be blended is preferably not greater than 5 parts by mass based on 100 parts by mass of the overall rubber component. This prevents the contamination of the photoreceptor body, for example, when the electrically conductive foam rubber roller 1 is used for an image forming apparatus.

Examples of the degradation preventing agent include various anti-aging agents and anti-oxidants.

The anti-oxidants serve to reduce the environmental dependence of the roller resistance of the electrically conductive foam rubber roller 1 and to suppress increase in roller resistance during continuous energization of the electrically conductive foam rubber roller 1. Examples of the anti-oxidants include nickel diethyldithiocarbamate (NOCRAC (registered trade name) NEC-P available from Ouchi Shinko Chemical Industrial Co., Ltd.) and nickel dibutyldithiocarbamate (NOCRAC NBC available from Ouchi Shinko Chemical Industrial Co., Ltd.)

Examples of the filler include zinc oxide, silica, carbon, carbon black, clay, talc, calcium carbonate, magnesium carbonate and aluminum hydroxide, which may be used either alone or in combination.

The blending of the filler improves the mechanical strength and the like of the electrically conductive foam rubber roller 1.

Electrically conductive carbon black may be used as the filler to impart the electrically conductive foam rubber roller 1 with electron conductivity.

As the filler, silica and carbon black are preferred which function as a rubber reinforcement material and effectively improve the tensile characteristics of the electrically conductive foam rubber roller 1. Carbon black is particularly preferred.

The proportion of the filler to be blended is preferably not less than 5 parts by mass and not greater than 50 parts by mass, particularly preferably not greater than 30 parts by mass, based on 100 parts by mass of the overall rubber component.

Examples of the anti-scorching agent include N-cyclohexylthiophthalimide, phthalic anhydride, N-nitrosodiphenylamine and 2,4-diphenyl-4-metyl-1-pentene, which may be used either alone or in combination. Particularly, N-cyclohexylthiophthalimide is preferred.

The proportion of the anti-scorching agent to be blended is preferably not less than 0.1 part by mass and not greater than 5 parts by mass, particularly preferably not greater than 1 part by mass, based on 100 parts by mass of the overall rubber component.

The co-crosslinking agent serves to crosslink itself as well as the rubber component to increase the overall molecular weight.

Examples of the co-crosslinking agent include ethylenically unsaturated monomers typified by methacrylic esters, metal salts of methacrylic acid and acrylic acid, polyfunctional polymers utilizing functional groups of 1,2-polybutadienes, and dioximes, which may be used either alone or in combination.

Examples of the ethylenically unsaturated monomers include:

(a) monocarboxylic acids such as acrylic acid, methacrylic acid and crotonic acid;
(b) dicarboxylic acids such as maleic acid, fumaric acid and itaconic acid;
(c) esters and anhydrides of the unsaturated carboxylic acids (a) and (b);
(d) metal salts of the monomers (a) to (c);
(e) aliphatic conjugated dienes such as 1,3-butadiene, isoprene and 2-chloro-1,3-butadiene;
(f) aromatic vinyl compounds such as styrene, α-methylstyrene, vinyltoluene, ethylvinylbenzene and divinylbenzene;
(g) vinyl compounds such as triallyl isocyanurate, triallyl cyanurate and vinylpyridine each having a hetero ring; and
(h) cyanovinyl compounds such as (meth)acrylonitrile and α-chloroacrylonitrile, acrolein, formyl sterol, vinyl methyl ketone, vinyl ethyl ketone and vinyl butyl ketone. These ethylenically unsaturated monomers may be used either alone or in combination.

Monocarboxylic acid esters are preferred as the esters (c) of the unsaturated carboxylic acids.

Specific examples of the monocarboxylic acid esters include:

alkyl (meth)acrylates such as methyl (meth)acrylate, ethyl (meth)acrylate, n-propyl (meth)acrylate, i-propyl (meth)acrylate, n-butyl (meth)acrylate, i-butyl (meth)acrylate, n-pentyl (meth)acrylate, i-pentyl (meth)acrylate, n-hexyl (meth)acrylate, cyclohexyl (meth)acrylate, 2-ethylhexyl (meth)acrylate, octyl (meth)acrylate, i-nonyl (meth)acrylate, tert-butylcyclohexyl (meth)acrylate, decyl (meth)acrylate, dodecyl (meth)acrylate, hydroxymethyl (meth)acrylate and hydroxyethyl (meth)acrylate;

aminoalkyl (meth)acrylates such as aminoethyl (meth)acrylate, dimethylaminoethyl (meth)acrylate and butylaminoethyl (meth)acrylate;

(meth)acrylates such as benzyl (meth)acrylate, benzoyl (meth)acrylate and aryl (meth)acrylates each having an aromatic ring;

(meth)acrylates such as glycidyl (meth)acrylate, methaglycidyl (meth)acrylate and epoxycyclohexyl (meth)acrylate each having an epoxy group;

(meth)acrylates such as N-methylol (meth)acrylamide, γ-(meth)acryloxypropyltrimethoxysilane, tetrahydrofurfuryl methacrylate each having a functional group; and

polyfunctional (meth)acrylates such as ethylene glycol di(meth)acrylate, trimethylolpropane tri(meth)acrylate, ethylene dimethacrylate (EDMA), polyethylene glycol dimethacrylate and isobutylene ethylene dimethacrylate. These monocarboxylic acid esters may be used either alone or in combination.

The rubber composition containing the aforementioned ingredients can be prepared in a conventional manner. First, the rubbers for the rubber component are blended in the predetermined proportions, and the resulting rubber component is simply kneaded. After additives other than the foaming component and the crosslinking component are added to and kneaded with the rubber component, the foaming component and the crosslinking component are finally added to and further kneaded with the resulting mixture. Thus, the rubber composition is provided. A kneader, a Banbury mixer, an extruder or the like, for example, is usable for the kneading.

### <<Image Forming Apparatus>>

The inventive image forming apparatus incorporates the inventive electrically conductive foam rubber roller 1. Examples of the inventive image forming apparatus include various electrophotographic image forming apparatuses such as a laser printer, an electrostatic copying machine, a plain paper facsimile machine and a printer-copier-facsimile multifunctional machine.

### EXAMPLES

### Example 1

### Preparation of Rubber Composition

A rubber component was prepared by blending 10 parts by mass of an ECO (HYDRIN (registered trade name) T3108 available from Zeon Corporation), 10 parts by mass of an EPDM (ESPRENE (registered trade name) EPDM505A available from Sumitomo Chemical Co., Ltd) and 80 parts by mass of an NBR (a non-oil-extension and lower-acrylonitrile-content type NBR JSR N250SL available from JSR Co., Ltd. and having an acrylonitrile content of 20%).

A rubber composition was prepared by blending ingredients shown below in Table 1 with 100 parts by mass of the overall rubber component, and kneading the resulting mixture at 80° C. for 3 to 5 minutes by means of an enclosed kneader.

TABLE 1

| Ingredients | Parts by mass |
|---|---|
| Filler | 10 |
| Foaming agent | 3 |
| Acid accepting agent | 3 |
| Crosslinking agent | 1.5 |
| Accelerating agent DM | 0.5 |
| Accelerating agent TS | 0.5 |
| Acceleration assisting agent | 5 |

The ingredients shown in Table 1 are as follows. The amounts (parts by mass) of the ingredients shown in Table 1 are based on 100 parts by mass of the overall rubber component.

Filler: Carbon black HAF (SEAST 3 (trade name) available from Tokai Carbon Co., Ltd.)
Foaming agent: ADCA foaming agent (VINYFOR AC#3 (trade name) available from Eiwa Chemical Industry Co., Ltd.)
Acid accepting agent: Hydrotalcites (DHT-4A-2 available from Kyowa Chemical Industry Co., Ltd.)
Crosslinking agent: Sulfur powder (available from Tsurumi Chemical Industry Co., Ltd.)
Accelerating agent DM: Di-2-benzothiazyl disulfide (NOCCELER (registered trade name) DM available from Ouchi Shinko Chemical Industrial Co., Ltd.)
Accelerating agent TS: Tetramethylthiuram disulfide (NOCCELER TS available from Ouchi Shinko Chemical Industrial Co., Ltd.)
Acceleration assisting agent: Zinc oxide (available from Hakusui Tech Co., Ltd.)

### (Adjustment of Die Head and Center Core)

Urge amounts to be applied between a die head 14 (having an opening 13 having an inner diameter of 10.5 mm) and a center core 16 (having a section 15 having an outer diameter of 3.5 mm) shown in FIGS. 4 and 5 in four directions by a fixing mechanism not shown were controlled so that an error calculated from the expression (1) based on a maximum value and a minimum value of distances d1 to d4 measured between the die head 14 and the center core 16 in four directions (corresponding to the four directions of the fixing mechanism), i.e., in upward, rightward, downward and leftward directions, with respect to the axis 17 was 30%.

(Production of Electrically Conductive Foam Rubber Roller)

The rubber composition was fed into the extruder 6 of the production apparatus 5 shown in FIG. 1, and extruded into a tubular body having an outer diameter of 10.5 mm and an inner diameter of 3.5 mm through an annular space defined between the die head 14 and the center core 16 controlled as satisfying the error condition by operating the extruder 6. The extruded tubular body 7 was continuously fed out in an elongated state without cutting to be continuously passed through the microwave crosslinking device 8 and the hot air crosslinking device 9, whereby the tubular body was continuously foamed and crosslinked.

The microwave crosslinking device 8 had an output of 8 kW and an internal control temperature of 160° C. The hot air crosslinking device 9 had an internal control temperature of 250° C. and an effective heating chamber length of 8 m.

The tubular body 7 had a thickness unevenness of 1.30 as measured in section immediately after being passed through the hot air crosslinking device 9.

In turn, the tubular body 7 was foamed, crosslinked and cooled, and then cut to a length of 220 mm. Thus, an electrically conductive foam rubber roller 1 was produced. The electrically conductive foam rubber roller 1 was secondarily crosslinked in a hot air oven at 160° C. for 1 hour, and a metal shaft 3 (of SUM-24L) having an outer diameter of 6 mm was press-inserted in a through-hole 2 of the electrically conductive foam rubber roller, whereby the shaft 3 is electrically connected to and mechanically fixed to the electrically conductive foam rubber roller 1. Then, an outer peripheral surface 4 of the electrically conductive foam rubber roller 1 was polished by a traverse polishing process utilizing a cylindrical polisher to be thereby finished as having an outer diameter of 12 mm.

### Example 2

The electrically conductive foam rubber roller 1 was produced in substantially the same manner as in Example 1, except that urge amounts to be applied between a die head 14 (having an opening 13 having an inner diameter of 10.5 mm) and a center core 16 (having a section 15 having an outer diameter of 3.5 mm) shown in FIGS. 4 and 5 in four directions not shown by a fixing mechanism were controlled so that an error calculated from the expression (1) based on a maximum value and a minimum value of distances dl to d4 measured between the die head 14 and the center core 16 in four directions (corresponding to the four directions of the fixing mechanism), i.e., in upward, rightward, downward and leftward directions, with respect to the axis 17 was 20%.

The tubular body 7 had a thickness unevenness of 1.20 as measured in section immediately after being passed through the hot air crosslinking device 9.

### Example 3

The electrically conductive foam rubber roller 1 was produced in substantially the same manner as in Example 1, except that the rubber component was prepared by blending 10 parts by mass of the ECO, 10 parts by mass of the EPDM, 40 parts by mass of the NBR and 40 parts by mass of an SBR (non-oil-extension type JSR1502 available from JSR Co., Ltd.) and urge amounts to be applied between a die head 14 (having an opening 13 having an inner diameter of 10.5 mm) and a center core 16 (having a section 15 having an outer diameter of 3.5 mm) shown in FIGS. 4 and 5 in four directions not shown by a fixing mechanism were controlled so that an error calculated from the expression (1) based on a maximum value and a minimum value of distances dl to d4 measured between the die head 14 and the center core 16 in four directions (corresponding to the four directions of the fixing mechanism), i.e., in upward, rightward, downward and leftward directions, with respect to the axis 17 was 25%.

The tubular body 7 had a thickness unevenness of 1.26 as measured in section immediately after being passed through the hot air crosslinking device 9.

### Example 4

The electrically conductive foam rubber roller 1 was produced in substantially the same manner as in Example 1, except that the rubber component was prepared by blending 10 parts by mass of the ECO, 10 parts by mass of the EPDM, and 80 parts by mass of the SBR, and urge amounts to be applied between a die head 14 (having an opening 13 having an inner diameter of 10.5 mm) and a center core 16 (having a section 15 having an outer diameter of 3.5 mm) shown in FIGS. 4 and 5 in four directions not shown by a fixing mechanism were controlled so that an error calculated from the expression (1) based on a maximum value and a minimum value of distances dl to d4 measured between the die head 14 and the center core 16 in four directions (corresponding to the four directions of the fixing mechanism), i.e., in upward, rightward, downward and leftward directions, with respect to the axis 17 was 30%.

The tubular body 7 had a thickness unevenness of 1.30 as measured in section immediately after being passed through the hot air crosslinking device 9.

### Comparative Example 1

The electrically conductive foam rubber roller 1 was produced in substantially the same manner as in Example 1, except that urge amounts to be applied between a die head 14 (having an opening 13 having an inner diameter of 10.5 mm) and a center core 16 (having a section 15 having an outer diameter of 3.5 mm) shown in FIGS. 4 and 5 in four directions not shown by a fixing mechanism were controlled so that an error calculated from the expression (1) based on a maximum value and a minimum value of distances dl to d4 measured between the die head 14 and the center core 16 in four directions (corresponding to the four directions of the fixing mechanism), i.e., in upward, rightward, downward and leftward directions, with respect to the axis 17 was 35%.

The tubular body 7 had a thickness unevenness of 1.34 as measured in section immediately after being passed through the hot air crosslinking device 9.

### Comparative Example 2

The electrically conductive foam rubber roller 1 was produced in substantially the same manner as in Example 3, except that urge amounts to be applied between a die head 14 (having an opening 13 having an inner diameter of 10.5 mm) and a center core 16 (having a section 15 having an outer diameter of 3.5 mm) shown in FIGS. 4 and 5 in four directions not shown by a fixing mechanism were controlled so that an error calculated from the expression (1) based on a maximum value and a minimum value of distances dl to d4 measured between the die head 14 and the center core 16 in four directions (corresponding to the four directions of the fixing mechanism), i.e., in upward, rightward, downward and leftward directions, with respect to the axis 17 was 40%.

The tubular body 7 had a thickness unevenness of 1.40 as measured in section immediately after being passed through the hot air crosslinking device 9.

### Comparative Example 3

The electrically conductive foam rubber roller 1 was produced in substantially the same manner as in Example 4, except that urge amounts to be applied between a die head 14 (having an opening 13 having an inner diameter of 10.5 mm) and a center core 16 (having a section 15 having an outer diameter of 3.5 mm) shown in FIGS. 4 and 5 in four directions not shown by a fixing mechanism were controlled so that an error calculated from the expression (1) based on a maximum value and a minimum value of distances dl to d4 measured between the die head 14 and the center core 16 in four directions (corresponding to the four directions of the fixing mechanism), i.e., in upward, rightward, downward and leftward directions, with respect to the axis 17 was 38%.

The tubular body 7 had a thickness unevenness of 1.38 as measured in section immediately after being passed through the hot air crosslinking device 9.

### <Check for Cracking>

The electrically conductive foam rubber rollers 1 of Examples and Comparative Examples were each cut along an axis thereof into eight circumferential portions after being cut to the predetermined length before the secondary crosslinking, and cut surfaces were checked for cracking.

The results are shown in Table 2.

TABLE 2

| | | | | | | |
|---|---|---|---|---|---|---|
| | | | | Comparative | Comparative | Comparative |
| Example 1 | Example 2 | Example 3 | Example 4 | Example 1 | Example 2 | Example 3 |

Parts by mass

| | | | | | | | |
|---|---|---|---|---|---|---|---|
| ECO | 10 | 10 | 10 | 10 | 10 | 10 | 10 |
| EPDM | 10 | 10 | 10 | 10 | 10 | 10 | 10 |
| NBR | 80 | 80 | 40 | 0 | 80 | 40 | 0 |
| SBR | 0 | 0 | 40 | 80 | 0 | 40 | 80 |

Evaluation

| | | | | | | | |
|---|---|---|---|---|---|---|---|
| Error (%) | 30 | 20 | 25 | 30 | 35 | 40 | 38 |
| Thickness unevenness | 1.30 | 1.20 | 1.26 | 1.30 | 1.34 | 1.40 | 1.38 |
| Cracking | No | No | No | No | Yes | Yes | Yes |

The results for Examples 1 to 4 and Comparative Examples 1 to 3 in Table 2 indicate that, where the tubular body 7 has a thickness unevenness of not greater than 1.3 immediately after being passed through the hot air crosslinking device 9, the resulting electrically conductive foam rubber roller 1 is free from internal cracking and hence free from exfoliation and indentation in the subsequent polishing step.

The results for Examples and Comparative Examples indicate that, where the die head 14 and the center core 16 shown in FIGS. 4 and 5 are used in combination for the extrusion of the tubular body 7, urge amounts to be applied between the die head 14 and the center core 16 in the four directions not shown by the fixing mechanism are preferably controlled so that an error calculated from the expression (1) based on a maximum value and a minimum value of distances dl to d4 measured between the die head 14 and the center core 16 in the upward, rightward, downward and leftward directions (corresponding to the four directions of the fixing mechanism) with respect to the axis 17 is not greater than 10% in order to reduce the thickness unevenness of the tubular body 7 to not greater than 1.3 immediately after the tubular body 7 is passed through the hot air crosslinking device 9.

This application corresponds to Japanese Patent Application No. 2013-164370 filed in the Japan Patent Office on Aug. 7, 2013, the disclosure of which is incorporated herein by reference in its entirety.

What is claimed is:

1. A production method for producing an electrically conductive foam rubber roller, the production method comprising the steps of:
continuously extruding an electrically-conductive crosslinkable foamable rubber composition into a tubular body; and
passing the extruded tubular body through a microwave crosslinking device and then through a hot air crosslinking device in an elongated state without cutting the tubular body to continuously foam and crosslink the tubular body;
wherein the rubber composition is extruded, foamed and crosslinked so that the tubular body has a thickness unevenness of not greater than 1.3 immediately after being passed through the hot air crosslinking device, the thickness unevenness being defined as a ratio Tₘₐₓ/Tₘᵢₙ between a maximum radial thickness Tₘₐₓ and a minimum radial thickness Tₘᵢₙ of the tubular body which are each measured radially of the tubular body in a cross section of the tubular body.

2. The electrically conductive foam rubber roller production method according to claim 1,
wherein the extruder includes a die head having a round opening and a center core provided in the die head and having a round cross section taken along the same plane as the opening of the die head,
wherein the die head and the center core of the extruder are positioned with respect to each other so that an error calculated from the following expression (1) is not greater than 10%:
Error(%)=(Max−Min)/Min×100 (1)
wherein Max and Min are a maximum value and a minimum value, respectively, of distances as measured between the opening of the die head and the center core radially of the opening in the same plane as the opening at different positions defined circumferentially of the opening.

3. An electrically conductive foam rubber roller produced by the production method according to claim 2.

4. An image forming apparatus comprising the electrically conductive foam rubber roller according to claim 3.
